(19) United States
(12) Patent Application Publication
(10) Pub. No.: US 2026/0266149 A1
(43) Pub. Date: Sep. 10, 2026

(54) Characterizing Gases in Wellbores

(71) Applicant: Saudi Arabian Oil Company, Dhahran (SA)

(72) Inventors: Sara Abu Alsaud, Al Qatif (SA); Klemens Katterbauer, Dhahran (SA); Abdallah A. AlShehri, Dhahran (SA)

(21) Appl. No.: 19/075,028

(22) Filed: Mar. 10, 2025

(51) Int. Cl. E21B 21/08; E21B 43/16; G01N 21/65

(52) U.S. Cl. CPC E21B 21/085; E21B 43/16; G01N 21/65

(57) ABSTRACT

This disclosure describes systems and methods including a downhole tool for underbalanced coiled tubing drilling. The tool includes two or more Raman spectroscopy units, where each Raman spectroscopy unit includes one or more Raman spectroscopy probes. A wireless communication unit is coupled to each Raman spectroscopy unit. A field programmable gate array (FPGA) is configured to receive data from each wireless communication unit and transmit the data to a computing system at a surface of a subsurface formation. Each wireless communication unit is configured to receive measurements from the respective Raman spectroscopy unit and transmit the measurements to the FPGA.

### TECHNICAL FIELD

The present disclosure relates to characterizing gases in wellbores.

### BACKGROUND

Underbalanced coiled tubing drilling (UBCTD) is a drilling method that can be used to drill wells to recover natural gas from depleted reservoirs. Underbalanced drilling involves maintaining the pressure in the wellbore lower than the pressure in the subsurface formation. Coiled tubing is a continuous length of steel or composite tubing that is wound onto a reel. UBCTD operations reduce the risk of damaging the subsurface formation by avoiding heavy drilling fluids, and do not require a full-scale drilling rig.

Underbalanced coiled tubing drilling (UBCTD) has become a valuable asset in enhancing hydrocarbon productivity and recovery through the usage of non-invasive fluid while drilling and reducing future workover stimulation costs, sidetracking, and drill string differential sticking events. Since underbalanced conditions induces fluid influx from the reservoir to the wellbore, UBCTD gives an excellent indication of the hydrocarbon presence in the targeted zones.

### SUMMARY

Under balanced coil tubing drilling (UBCTD) can be used for drilling wells with extra slimholes (e.g., boreholes with a diameter less than 4 inches, or typically 3-⅝ inches). Due to the small diameter of the borehole, UBCTD has limited formation evaluation and logging capabilities compared with traditional drilling operations. For example, a UBCTD well can be geo-steered based on gamma ray readings, which show the lithology of the formation without any indication of gas presence. Cutting analysis can be used in bio-steering the well based on the visual porosity and mineral analysis from accumulated powdered cuttings that may be contaminated or not representative of the depth from which it was taken. Ultra-slim resistivity tools can be used that take measurements based on the electrical conduction characteristic of the fluid to distinguish hydrocarbons from water; however, resistivity tools are unable to distinguish different gas composition and molecules. Since nitrogen gas is primarily used while drilling UBCTD wells to reduce the hydrostatic pressure in the wellbore, distinguishing different gas composition can improve the steering and recovery capabilities in UBCTD operations by identifying where hydrocarbon gases enter the wellbore from the reservoir.

This disclosure describes systems and methods for characterizing gas compositions in a wellbore. A downhole tool can determine real time gas compositions to support geosteering and navigation while drilling underbalanced coiled tubing laterals. The tool can use Raman based spectroscopy probes to determine the gas compositions and an internal flowmeter to measure an influx of drilling fluid into the wellbore. These systems and methods can deliver the results in real time to an end user by utilizing internet of things (IoT) technologies through a field programmable gated array (FPGA) device that is communicatively connected to the Raman based spectroscopy probes.

In an example implementation, a downhole tool for underbalanced coiled tubing drilling includes two or more Raman spectroscopy units. Each Raman spectroscopy unit can include one or more Raman spectroscopy probes. A wireless data communication unit can be coupled to each Raman spectroscopy unit to receive measurements from the respective Raman spectroscopy unit and transmit the measurements. An FPGA can be configured to receive data from each wireless data communications unit and transmit the data to a computing system at a surface of the subsurface formation.

Implementations of the systems and methods of this disclosure can provide various technical benefits. For example, these systems and methods can identify and differentiate borehole gases from injected nitrogen. Using multiple probes can detect the gas influx coming from multiple directions in the borehole while drilling. These systems and methods can identify the locations of gas influx with more precision as compared with methods that measure gas at the surface after flaring. The measurements can be made in the borehole and communicated to the surface in real-time to inform geosteering of the wellbore trajectory. The downhole tool can be connected to the bottom hole assembly that is attached and powered by the coiled tubing. Wireless transmission of data in the borehole uses fewer cables that could be damaged during the drilling operations thereby improving the robustness and reliability of the downhole tool. These systems and methods can be used to revive production in extremely low pressure gas reservoirs by identifying locations of gas influx in underbalanced conditions and steering the well to reside in the identified locations. These systems and methods obtain in-situ measurements of gases in a borehole thereby avoiding challenges caused by contamination of samples brought to the surface and challenges arising with contamination of samples prior to completion of the well.

The details of one or more embodiments of these systems and methods are set forth in the accompanying drawings and the description below. Other features, objects, and advantages of these systems and methods will be apparent from the description and drawings, and from the claims.

### DESCRIPTION OF DRAWINGS

FIG. 1 is a schematic diagram of an example UBCTD LWD operation to drill a well in a subsurface formation.

FIG. 2 is a schematic of a downhole tool for characterizing gases in a wellbore.

FIG. 3 is a plan view of a flow meter.

FIGS. 4A-4C are schematic plan views of Raman spectroscopy units.

FIG. 5 is a flow chart for a method of characterizing gases in a wellbore.

FIG. 6 is a block diagram illustrating an example computer system used to provide computational functionalities associated with described algorithms, methods, functions, processes, flows, and procedures according to some implementations of the present disclosure.

Like reference symbols in the various drawings indicate like elements.

### DETAILED DESCRIPTION

Under balanced coil tubing drilling (UBCTD) can be used for drilling wells with extra slimholes (e.g., boreholes with a diameter less than 4 inches, or typically 3-⅝ inches). Due to the small diameter of the borehole, UBCTD has limited formation evaluation and logging capabilities compared with traditional drilling operations. For example, a UBCTD well can be geo-steered based on gamma ray readings, which show the lithology of the formation without any indication of gas presence. Cutting analysis can be used in bio-steering the well based on the visual porosity and mineral analysis from accumulated powdered cuttings that may be contaminated or not representative of the depth from which it was taken. Ultra-slim resistivity tools can be used that take measurements based on the electrical conduction characteristic of the fluid to distinguish hydrocarbons from water; however, resistivity tools are unable to distinguish different gas composition and molecules. Since nitrogen gas is primarily used while drilling UBCTD wells to reduce the hydrostatic pressure in the wellbore, distinguishing different gas composition can improve the steering and recovery capabilities in UBCTD operations by identifying where hydrocarbon gases enter the wellbore from the reservoir.

This disclosure describes systems and methods for characterizing gas compositions in a wellbore. A downhole tool can determine real time gas compositions to support geosteering and navigation while drilling underbalanced coiled tubing laterals. The tool can use Raman based spectroscopy probes to determine the gas compositions and an internal flowmeter to measure an influx of drilling fluid into the wellbore. These systems and methods can deliver the results in real time to an end user by utilizing internet of things (IoT) technologies through a field programmable gated array (FPGA) device that is communicatively connected to the Raman based spectroscopy probes.

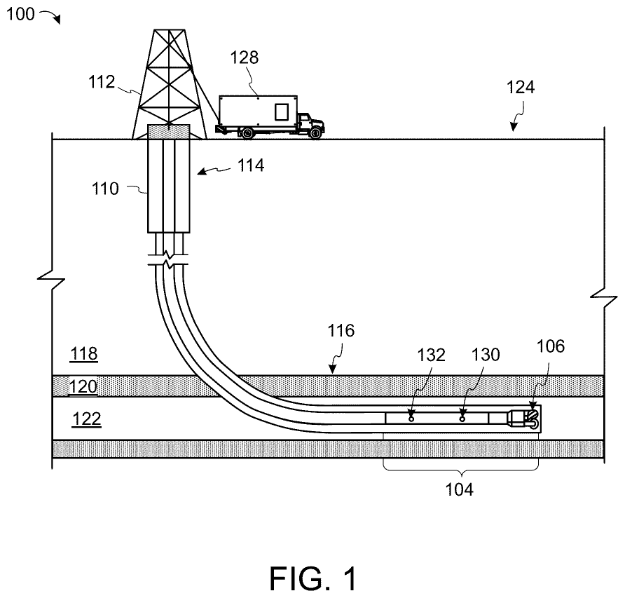

FIG. 1 is a schematic diagram illustrating an LWD operation 100 in which a wellbore 110 extends downhole from a wellhead 112. Wellbore 110 includes a vertical portion 114 and a horizontal portion 116. The wellbore 110 can be a slimhole or an extra slimhole drilled with UBCTD. LWD operations can be performed in other types of wellbores, for example, slanted wellbores, vertical wellbores, and/or horizontal wellbores. In the LWD operation 100, the wellbore 110 penetrates through three layers 118, 120, and 122 of a subsurface formation 124.

The bottom hole assembly (BHA) 104 includes the drill bit 106 and a string of one or more instruments with sensors operable to measure petrophysical properties of the subsurface formation 124. For example, a resistivity logging tool 130 measures the subsurface electrical resistivity, which is the ability to impede the flow of electric current around the wellbore. A gamma ray logging tool 132 measures naturally occurring gamma radiation to characterize rock or sediment around the borehole. Resistivity logs can help a data processing system differentiate between formations filled with salty waters (good conductors of electricity) and those filled with hydrocarbons (poor conductors of electricity). Other types of logs can also be included in larger diameter wellbores. Porosity logs measure the fraction or percentage of pore volume in a volume of rock using acoustic or nuclear technology. Acoustic logs measure characteristics of sound waves propagated through the well-bore environment. Nuclear logs utilize nuclear reactions that take place in the downhole logging instrument or in the formation. Density logs measure the bulk density of a formation by bombarding it with a radioactive source and measuring the resulting gamma ray count after the effects of Compton scattering and photoelectric absorption. Sonic logs provide a formation interval transit time, which typically is a function of lithology and rock texture but particularly porosity. The logging tool includes a piezoelectric transmitter and receiver and the time taken for the sound wave to travel the fixed distance between the two is recorded as an interval transit time.

As the BHA 104 travels downhole, the sensors of the BHA measure formation properties to generate a well log that is recorded at the control truck 128. In the illustrated operation, the data are recorded at the control truck 128 in real-time. Real-time data are recorded directly against measured drilled depth. The real-time data can be recorded by a data processing system within the control truck 128. The data processing system can process the recorded real-time data for use while drilling the wellbore. Alternatively, or additionally, the data processing system can upload the data to a network or cloud server to be processed by a separate computer or data processing system.

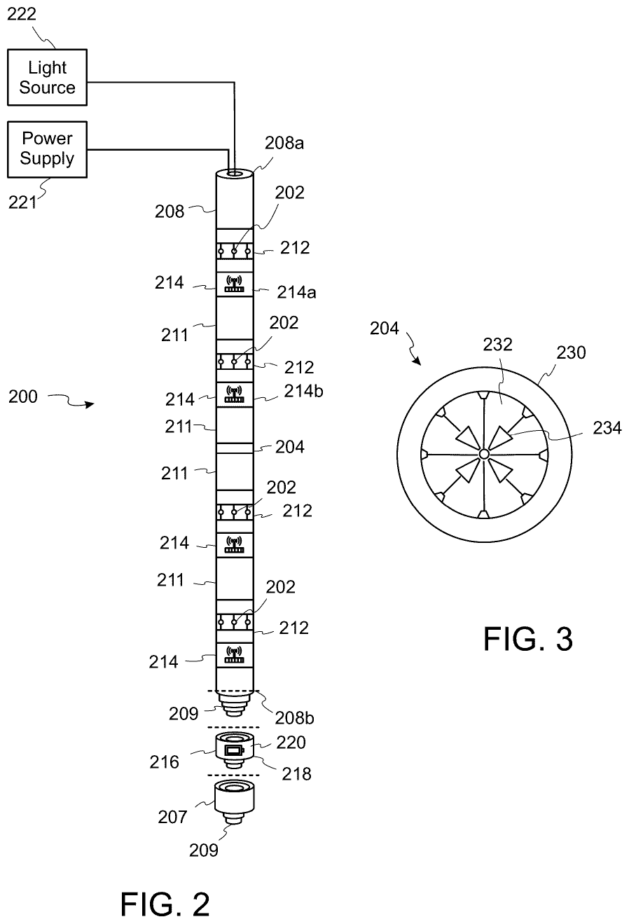

FIG. 2 is a schematic for an example downhole tool 200 for characterizing gas compositions in a wellbore. The downhole tool 200 can determine the gas composition in real time for geo-navigation for UBCTD operations. The downhole tool 200 includes multipole Raman based spectroscopy probes 202 and an interior flow meter 204. The downhole tool 200 can transmit gas compositional results in real time to an end user by utilizing IoT concepts through an FPGA device 206 that is connected to the probes 202. The downhole tool 200 can be included as a part of a BHA for UBCTD operations (e.g., BHA 104 in operation 100). The downhole tool 200 can be used in place of or in addition to other downhole tools in the BHA (e.g., resistivity logging tools or gamma ray logging tools).

The downhole tool 200 includes an elongate body 208 that houses the subcomponents of the downhole tool 200. The elongate body 208 has a central bore 210 to allow drilling fluid to flow through the downhole tool 200. The elongate body 208 can be formed, for example, by assembling annular subcomponents (e.g., probes 202, flow meter 204, etc.) of the downhole tool 200. The elongate body 208 can include non-instrumented sections 211 positioned between other subcomponents. At an uphole end 208a, the elongate body 208 is configured to be coupled to coiled tubing or another downhole tool. Similarly, at a downhole end 208b, the elongate body 208 is configured to be coupled to a bit-steered motor connection 207 or other downhole tool in the BHA. The diameter of the elongate body 208 can be, for example, 3 inches (76.2 mm) to fit within the slim UBCTD wellbore. The elongate body 208 can include magnetic screw threads 209 to couple with other components in the BHA. Using magnetic screw threads 209 can be advantageous because the magnetic screw threads enable a stronger connection and better alignment as compared with standard pipe threads.

The downhole tool 200 includes multiple Raman-based spectroscopy units 212. Each Raman-based spectroscopy unit 212 includes one or more (e.g., two or more or three or more) Raman-based spectroscopy probes 202. These probes 202 can identify and differentiate borehole gases based on inelastic scattering of photons from the gas molecules. Inelastic scattering occurs when the scattered photons acquire vibrational energy from an excitation laser and undergo a transition to another energy state. Raman scattering can be categorized into Stokes and anti-Stokes shifts in the light spectra, based on the final energy levels of the photons. For example, if the final energy state of the gas molecule is higher than the initial energy state of the gas molecules, the scattered photon will be shifted to a lower frequency (lower energy) than the incident photon. The shift in frequency to a lower frequency is a Stokes shift. Similarly, if the final energy state of the gas molecules is less than the initial energy state, the scattered photon will be shifted to a higher frequency (higher energy) known as an anti-Stokes shift. The Stokes and anti-Stokes lines in the spectra are distinctive indicators of the molecular structure of gases and substances present in the borehole. By having multiple probes 202 distributed in the downhole tool 200, the gas influx coming from multiple directions in the borehole can be detected while drilling. Additionally, the probes 202 can differentiate the type of gases present, such as methane, ethane, carbon dioxide, hydrogen sulfide, and nitrogen.

The probes 202 are optically coupled to a light source 222 located at the surface. For example, the probes 202 can be coupled to the light source 222 through fiber optic cables. The light source 222 can be, for example, a laser source or other monochromatic light source. Examples of suitable light sources include continuous-wave lasers having wavelengths between 200 and 1500 nanometers (nm). The wavelength chosen for the laser can depend on the requirements of the specific application. Using a single light source for the multiple probes 202 is advantageous for alignment of the probes 202 and to reduce the size of the probes 202. Because all of the probes 202 use a single light source, the probes 202 have aligned wavelengths thereby overcoming challenges relative to calibration and operation of individual light sources.

Each Raman spectroscopy unit 212 is coupled to a wireless communications unit 214. The wireless communications unit 214 includes circuitry to transmit and receive wireless signals, e.g., electromagnetic waves, to transfer data from the Raman spectroscopy unit 212 to a Field Programmable Gate Array (FPGA) device 216. The wireless communications can be transmitted directly to the FPGA device 216. Alternatively, the data is transmitted to the FPGA device 216 through a short-hop communications method. For example, a first wireless communications unit 214a can transmit data to a second wireless communications unit 214b that is closer to the FPGA device 216. The second wireless communications unit 214b functions as a repeater by transmitting (e.g., forwarding) the data from the first wireless communications unit 214a to the FPGA device 216 or to another wireless communications device 214 to move the data closer to the FPGA device 216. Using wireless communications in the wellbore is advantageous because it reduces the number of electrical connection cables in the downhole tool 200 thereby improving the maintainability and robustness of the downhole tool 200.

The FPGA device 216 is a computing device that records and stores the data from the probes 202. Additionally, the FPGA device 216 can control the operation of the Raman spectroscopy units 212. For example, the FPGA device 216 can transmit a wireless signal to the Raman spectroscopy units 212 to initiate collection of data. The FPGA device 216 can also transmit data to the surface (e.g., to a control center or control truck such as control truck 128). The FPGA device 216 can be configured to transmit data to the surface through a wired connection (e.g., an electric line or e-line) of the UBCTD system. The wired connection enables the data to be transferred to the surface in real-time. The real-time data transmission enables the drilling parameters (e.g., geosteering, rate of penetration, etc.) to be adjusted based on the conditions in the wellbore. The FPGA device 216 is advantageous, as compared to other processing devices, because it has lower latency, can be tailored to the particular processes of the downhole tool, and are energy efficient.

The FPGA is integrated into a power module 218 that also includes a wireless communications device 220 to wirelessly communicate with the Raman spectroscopy units 212. The power module 218 is coupled to a power supply 221 located at the surface. The power supply 221 can provide power to each of the sensors, modules, or units in the downhole tool 200. The power supply 221 can be the same power supply that powers other components in the BHA. Alternatively, the power supply 221 can be a dedicated power supply for the downhole tool 200.

FIG. 3 is a schematic plan view of an example flow meter 204 for use in the downhole tool 200. The flow meter 204 includes an annular body 230 defining a central opening 232. The flow meter 204 includes a spinner 234 (e.g., an impeller). When fluid is flowing through the central opening 232, the spinner 234 rotates, and the rotational speed of the spinner 234 indicates the flow rate of the fluid. The flow meter 204 is communicatively coupled to the FPGA device 216 to enable the flow rate to be transmitted to the surface. In a UBCTD operation, the fluid flowing through the flow meter 204 can primarily be a mixture of a water-based mud and nitrogen. The nitrogen decreases the density of the fluid thereby decreasing the hydrostatic head in the wellbore to maintain underbalanced conditions. Measuring the fluid flow rate and corresponding influx velocity is advantageous because it enables the effects of the drilling fluid on the downhole tool 200 to be balanced in the measurements. The influx velocity affects the stationarity and separation of the fluid. Using the influx velocity, the FPGA can determine, for example, if the flow of fluid is turbulent or not.

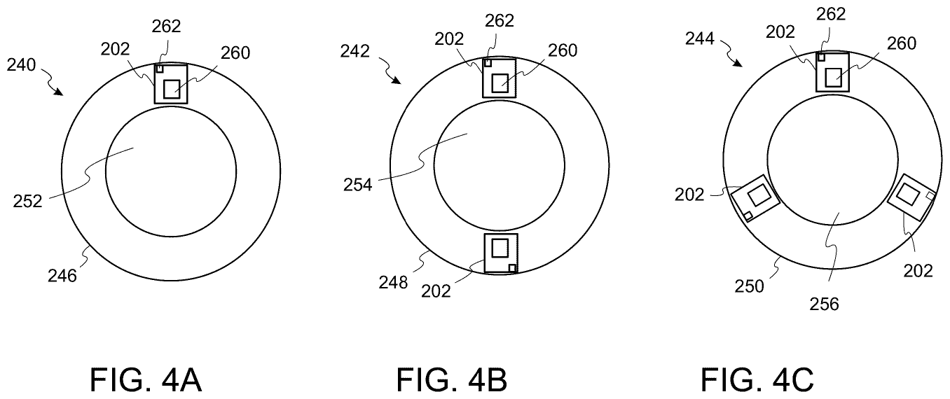

FIGS. 4A-4C show schematic plan views of Raman spectroscopy units 240, 242, 244 (e.g., Raman spectroscopy units 212) with differing numbers and layouts of probes 202. Unit 240 includes a single probe 202. Unit 242 includes two probes 202 positioned diametrically opposed to each other. Unit 244 includes three probes 202 space approximately equidistant around the circumference of the unit 244. Each of the units 240, 242, 244 includes an annular housing 246, 248, 250 with a central opening 252, 254, 256 to enable the drilling fluid to flow through the center of the downhole tool.

Each probe 202 includes a detector 260 and a light output 262. The light output 262 is optically coupled to the light source 222. The detector 260 can be, for example, a charge coupled device (CCD). The detector 260 can receive backscattered light from the gas molecules. Based on the backscattered light, the gas molecules in the wellbore can be identified.

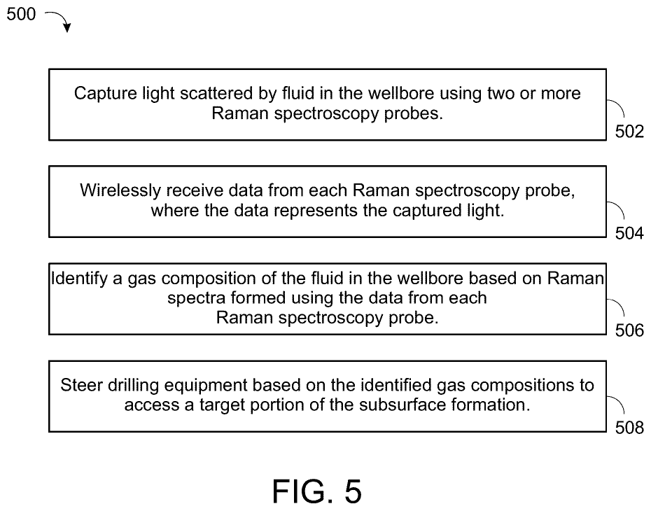

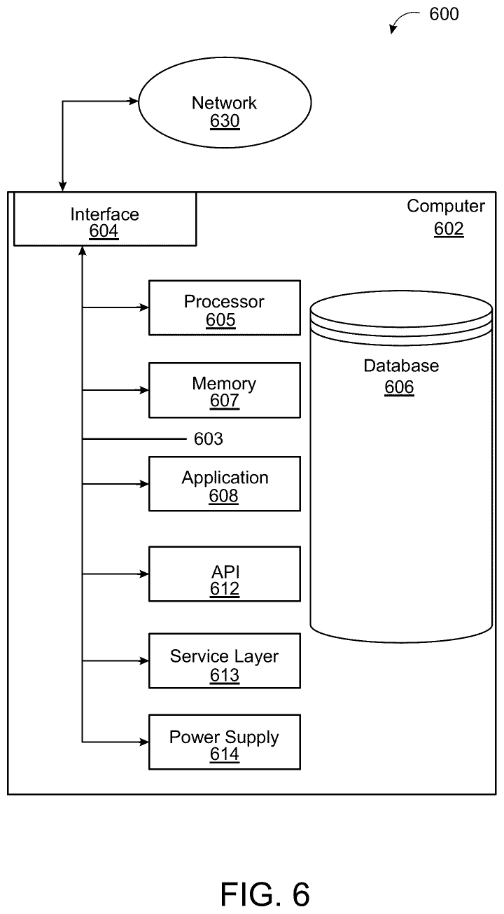

FIG. 5 is a flow chart for an example method 500 for characterizing gas in a wellbore. The method 500 can be used, for example, in a UBCTD operation to enable real-time feedback for geosteering a well trajectory. The method 500 can be implemented by a data processing system (e.g., FPGA device 216 or the computer of FIG. 6). The data processing system can be located in a downhole tool, at the surface, and/or at a remote location. In some implementations, portions of the method 500 are implemented on more than one data processing system.

The data processing system captures light scattered by fluid in the wellbore using two or more Raman spectroscopy probes in an underbalanced coiled tubing drilling logging-while-drilling tool (step 502). For example, the data processing system initiates the capture of light by the Raman spectroscopy probes by transmitting an electrical signal to the probes to change an operational state of the Raman spectroscopy probes.

The data processing system wirelessly receives data from each Raman spectroscopy probe (step 504). The data represents the scattered light captured by the Raman spectroscopy probes. In some implementations, the data processing system receives the data from one or more Raman spectroscopy probes through one or more signal repeaters. For example, a repeater associated with a first Raman spectroscopy probe of the Raman spectroscopy probes, second data transmitted from a second Raman spectroscopy probe; and transmitting by the repeater the second data to the FPGA.

The data processing system identifies a gas composition of the fluid in the wellbore based on Raman spectra formed using the data from each Raman spectroscopy probe (step 506). For example, the data processing system can identify the gas composition from the Raman spectra using a multi-peak identification system.

The data processing system can measure a flow rate of drilling fluid flowing through the logging-while-drilling fluid using a flow meter. For example, the data processing system can receive an electrical signal from the flow meter, and based on the electrical signal, the data processing system can determine the flow rate. The data processing system can determine the influx velocity of the drilling fluid into the wellbore based on the flow rate. The data processing system can use the influx velocity to determine potential gas compositions of the wellbore fluids and/or a separateness of the fluid types in the wellbore.

In some implementations, the data processing system transmits data to another computing device located such that an end user can access the data. For example, a data processing system in the wellbore (e.g., the FPGA device) can transmit the data to a computing device located at the surface to enable an operator of the drill to access the data. The data can be, for example, the data from the Raman spectroscopy probes. Alternatively, or additionally, the data can include processed data such as the identified gas compositions, the location in the borehole, and/or the flow rate of the drilling fluid.

In some implementations, the data processing system steers drilling equipment by controlling a direction of a drill bit based on the identified gas compositions to access a target portion of the subsurface formation (step 508). For example, the data processing system can determine the direction of the drill bit based on locations of the Raman spectroscopy probes on the logging-while-drilling tool from which a desired gas composition is identified. The direction can be, for example, toward the locations where desired gases (e.g., hydrocarbons) are identified or away from locations where undesired gas compositions are identified.

The method 500 can be performed in real-time. Real-time or near real-time processing and/or communication refers to a scenario in which received data (e.g., spectral data) are processed as made available to systems and devices requesting those data immediately (e.g., within milliseconds, tens of milliseconds, or hundreds of milliseconds) after the processing of those data are completed, without introducing data persistence or store-then-forward actions. In this context, a wireless communications system is configured to process spectral data as it arrives and transmit an elemental analysis as quickly as possible (though processing latency may occur). Though data can be buffered between module interfaces in a pipelined architecture, each individual module operates on the most recent data available to it. The overall result is a workflow that, in a real-time context, receives a data stream (e.g., spectral data) and outputs processed data (e.g., gas compositions) based on that data stream in a first-in, first out manner. However, non-real-time contexts are also possible, in which data are stored (either in memory or persistently) for processing at a later time. In this context, modules of the data processing system do not necessarily operate on the most recent data available.

FIG. 6 is a block diagram of an example computer system 600 used to provide computational functionalities associated with described algorithms, methods, functions, processes, flows, and procedures described in the present disclosure, according to some implementations of the present disclosure. The illustrated computer 602 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 602 can include input devices such as keypads, keyboards, and touch screens that can accept user information. Also, the computer 602 can include output devices that can convey information associated with the operation of the computer 602. The information can include digital data, visual data, audio information, or a combination of information. The information can be presented in a graphical user interface (UI) (or GUI).

The computer 602 can serve in a role as a client, a network component, a server, a database, a persistency, or components of a computer system for performing the subject matter described in the present disclosure. The illustrated computer 602 is communicably coupled with a network 630. In some implementations, one or more components of the computer 602 can be configured to operate within different environments, including cloud-computing-based environments, local environments, global environments, and combinations of environments.

At a high level, the computer 602 is an electronic computing device operable to receive, transmit, process, store, and manage data and information associated with the described subject matter. According to some implementations, the computer 602 can also include, or be communicably coupled with, an application server, an email server, a web server, a caching server, a streaming data server, or a combination of servers.

The computer 602 can receive requests over network 630 from a client application (for example, executing on another computer 602). The computer 602 can respond to the received requests by processing the received requests using software applications. Requests can also be sent to the computer 602 from internal users (for example, from a command console), external (or third) parties, automated applications, entities, individuals, systems, and computers.

Each of the components of the computer 602 can communicate using a system bus 603. In some implementations, any, or all of the components of the computer 602, including hardware or software components, can interface with each other or the interface 604 (or a combination of both), over the system bus 603. Interfaces can use an application programming interface (API) 612, a service layer 613, or a combination of the API 612 and service layer 613. The API 612 can include specifications for routines, data structures, and object classes. The API 612 can be either computer-language independent or dependent. The API 612 can refer to a complete interface, a single function, or a set of APIs.

The service layer 613 can provide software services to the computer 602 and other components (whether illustrated or not) that are communicably coupled to the computer 602. The functionality of the computer 602 can be accessible for all service consumers using this service layer. Software services, such as those provided by the service layer 613, can provide reusable, defined functionalities through a defined interface. For example, the interface can be software written in JAVA, C++, or a language providing data in extensible markup language (XML) format. While illustrated as an integrated component of the computer 602, in alternative implementations, the API 612 or the service layer 613 can be stand-alone components in relation to other components of the computer 602 and other components communicably coupled to the computer 602. Moreover, any or all parts of the API 612 or the service layer 613 can be implemented as child or sub-modules of another software module, enterprise application, or hardware module without departing from the scope of the present disclosure.

The computer 602 includes an interface 604. Although illustrated as a single interface 604 in FIG. 6, two or more interfaces 604 can be used according to particular needs, desires, or particular implementations of the computer 602 and the described functionality. The interface 604 can be used by the computer 602 for communicating with other systems that are connected to the network 630 (whether illustrated or not) in a distributed environment. Generally, the interface 604 can include, or be implemented using, logic encoded in software or hardware (or a combination of software and hardware) operable to communicate with the network 630. More specifically, the interface 604 can include software supporting one or more communication protocols associated with communications. As such, the network 630 or the interface's hardware can be operable to communicate physical signals within and outside of the illustrated computer 602.

The computer 602 includes a processor 605. Although illustrated as a single processor 605 in FIG. 6, two or more processors 605 can be used according to particular needs, desires, or particular implementations of the computer 602 and the described functionality. Generally, the processor 605 can execute instructions and can manipulate data to perform the operations of the computer 602, including operations using algorithms, methods, functions, processes, flows, and procedures as described in the present disclosure.

The computer 602 also includes a database 606 that can hold data for the computer 602 and other components connected to the network 630 (whether illustrated or not). For example, database 606 can be an in-memory, conventional, or a database storing data consistent with the present disclosure. In some implementations, database 606 can be a combination of two or more different database types (for example, hybrid in-memory and conventional databases) according to particular needs, desires, or particular implementations of the computer 602 and the described functionality. Although illustrated as a single database 606 in FIG. 6, two or more databases (of the same, different, or combination of types) can be used according to particular needs, desires, or particular implementations of the computer 602 and the described functionality. While database 606 is illustrated as an internal component of the computer 602, in alternative implementations, database 606 can be external to the computer 602.

The computer 602 also includes a memory 607 that can hold data for the computer 602 or a combination of components connected to the network 630 (whether illustrated or not). Memory 607 can store any data consistent with the present disclosure. In some implementations, memory 607 can be a combination of two or more different types of memory (for example, a combination of semiconductor and magnetic storage) according to particular needs, desires, or particular implementations of the computer 602 and the described functionality. Although illustrated as a single memory 607 in FIG. 6, two or more memories 607 (of the same, different, or combination of types) can be used according to particular needs, desires, or particular implementations of the computer 602 and the described functionality. While memory 607 is illustrated as an internal component of the computer 602, in alternative implementations, memory 607 can be external to the computer 602.

The application 608 can be an algorithmic software engine providing functionality according to particular needs, desires, or particular implementations of the computer 602 and the described functionality. For example, application 608 can serve as one or more components, modules, or applications. Further, although illustrated as a single application 608, the application 608 can be implemented as multiple applications 608 on the computer 602. In addition, although illustrated as internal to the computer 602, in alternative implementations, the application 608 can be external to the computer 602.

The computer 602 can also include a power supply 614. The power supply 614 can include a rechargeable or non-rechargeable battery that can be configured to be either user-or non-user-replaceable. In some implementations, the power supply 614 can include power-conversion and management circuits, including recharging, standby, and power management functionalities. In some implementations, the power-supply 614 can include a power plug to allow the computer 602 to be plugged into a wall socket or a power source to, for example, power the computer 602 or recharge a rechargeable battery.

There can be any number of computers 602 associated with, or external to, a computer system containing computer 602, with each computer 602 communicating over network 630. Further, the terms “client,” “user,” and other appropriate terminology can be used interchangeably, as appropriate, without departing from the scope of the present disclosure. Moreover, the present disclosure contemplates that many users can use one computer 602 and one user can use multiple computers 602.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware-or software-based (or a combination of both hardware-and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example LINUX, UNIX, WINDOWS, MAC OS, ANDROID, or IOS.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

A number of embodiments of these systems and methods have been described. Nevertheless, it will be understood that various modifications may be made without departing from the spirit and scope of this disclosure. Accordingly, other embodiments are within the scope of the following claims.

### EXAMPLES

In an example implementation, a downhole tool for underbalanced coiled tubing drilling includes two or more Raman spectroscopy units. Each Raman spectroscopy unit includes one or more Raman spectroscopy probes. A wireless communication unit is coupled to each Raman spectroscopy unit; and a field programmable gate array (FPGA) is configured to receive data from each wireless communication unit and transmit the data to a computing system at a surface of a subsurface formation. Each wireless communication unit is configured to receive measurements from the respective Raman spectroscopy unit and transmit the measurements to the FPGA.

An aspect combinable with the example implementation includes a flow meter configured to measure a flow rate of drilling slurry flowing through a central bore of the downhole tool.

In another aspect combinable with one, some, or all of the previous aspects, each Raman spectroscopy unit has an annular shape with a central bore to enable drilling fluid to flow through a center of the Raman spectroscopy unit.

In another aspect combinable with one, some, or all of the previous aspects, the wireless communication unit is configured to receive data from a second wireless communication unit and forward the data to the FPGA.

Another aspect combinable with one, some, or all of the previous aspects includes a light source optically coupled to each Raman spectroscopy probe.

In another aspect combinable with one, some, or all of the previous aspects, each Raman spectroscopy probe includes a light source outlet and a detector to capture scattered light.

Another aspect combinable with one, some, or all of the previous aspects includes a power module disposed at an end of the downhole tool. The FPGA is disposed within the power module, and the power module includes a wireless communications device communicatively coupled to the FPGA to receive the data from each wireless communication unit.

In another example implementation, a bottom hole assembly for underbalanced coiled tubing drilling includes a logging-while-drilling tool. The logging-while-drilling tool includes two or more Raman spectroscopy units. Each Raman spectroscopy unit includes one or more Raman spectroscopy probes. The logging-while-drilling tool includes a wireless communication unit coupled to each Raman spectroscopy unit; and a field programmable gate array (FPGA) configured to receive data from each wireless communication unit and transmit the data to a computing system at a surface of a subsurface formation. Each wireless communication unit is configured to receive measurements from the respective Raman spectroscopy unit and transmit the measurements to the FPGA.

In an aspect combinable with the example implementation, the logging-while-drilling tool includes a flow meter configured to measure a flow rate of drilling slurry flowing through a central bore of the logging-while-drilling tool.

In another aspect combinable with one, some, or all of the previous aspects, each Raman spectroscopy unit has an annular shape with a central bore to enable drilling fluid to flow through a center of the Raman spectroscopy unit.

In another aspect combinable with one, some, or all of the previous aspects, the wireless communication unit is configured to receive data from a second wireless communication unit and forward the data to the FPGA.

In another aspect combinable with one, some, or all of the previous aspects, the logging-while-drilling tool includes a light source optically coupled to each Raman spectroscopy probe.

In another aspect combinable with one, some, or all of the previous aspects, each Raman spectroscopy probe includes a light source outlet and a detector to capture scattered light.

In another aspect combinable with one, some, or all of the previous aspects, the logging-while-drilling tool includes a power module disposed at an end of the logging-while-drilling tool, The FPGA is disposed within the power module, and the power module includes a wireless communications device communicatively coupled to the FPGA to receive the data from each wireless communication unit.

In another example implementation, a method for characterizing gas in a wellbore includes capturing light scattered by fluid in the wellbore using two or more Raman spectroscopy probes in an underbalanced coiled tubing drilling logging-while-drilling tool; wirelessly receiving data, from each Raman spectroscopy probe by a field programmable gated array (FPGA) disposed in the logging-while-drilling tool, the data representing the captured light; and identifying a gas composition of the fluid in the wellbore based on Raman spectra formed using the data from each Raman spectroscopy probe.

An aspect combinable with the example implementation includes geosteering a well trajectory of the wellbore by controlling a direction of a drill bit based on the identified gas compositions.

In another aspect combinable with one, some, or all of the previous aspects, the direction of the drill bit is determined based on locations of the Raman spectroscopy probes on the logging-while-drilling tool from which a desired gas composition is identified.

Another aspect combinable with one, some, or all of the previous aspects includes transmitting data from the FPGA to a computing device located for access by an end user.

In another aspect combinable with one, some, or all of the previous aspects includes measuring a flow rate of drilling fluid flowing through the logging-while-drilling tool; and determining an influx velocity of the drilling fluid.

Another aspect combinable with one, some, or all of the previous aspects includes receiving, by a repeater associated with a first Raman spectroscopy probe of the Raman spectroscopy probes, second data transmitted from a second Raman spectroscopy probe; and transmitting, by the repeater, the second data to the FPGA.

What is claimed is:

1. A downhole tool for underbalanced coiled tubing drilling comprising:
two or more Raman spectroscopy units, each Raman spectroscopy unit comprising one or more Raman spectroscopy probes;
a wireless communication unit coupled to each Raman spectroscopy unit; and
a field programmable gate array (FPGA) configured to receive data from each wireless communication unit and transmit the data to a computing system at a surface of a subsurface formation,
wherein each wireless communication unit is configured to receive measurements from the respective Raman spectroscopy unit and transmit the measurements to the FPGA.

2. The downhole tool of claim 1, further comprising a flow meter configured to measure a flow rate of drilling slurry flowing through a central bore of the downhole tool.

3. The downhole tool of claim 1, wherein each Raman spectroscopy unit has an annular shape with a central bore to enable drilling fluid to flow through a center of the Raman spectroscopy unit.

4. The downhole tool of claim 1, wherein the wireless communication unit is configured to receive data from a second wireless communication unit and forward the data to the FPGA.

5. The downhole tool of claim 1, further comprising a light source optically coupled to each Raman spectroscopy probe.

6. The downhole tool of claim 5, wherein each Raman spectroscopy probe comprises a light source outlet and a detector to capture scattered light.

7. The downhole tool of claim 1, further comprising a power module disposed at an end of the downhole tool, wherein the FPGA is disposed within the power module, and the power module comprises a wireless communications device communicatively coupled to the FPGA to receive the data from each wireless communication unit.

8. A bottom hole assembly for underbalanced coiled tubing drilling comprising:
a logging-while-drilling tool comprising:
two or more Raman spectroscopy units, each Raman spectroscopy unit comprising one or more Raman spectroscopy probes;
a wireless communication unit coupled to each Raman spectroscopy unit; and
a field programmable gate array (FPGA) configured to receive data from each wireless communication unit and transmit the data to a computing system at a surface of a subsurface formation,
wherein each wireless communication unit is configured to receive measurements from the respective Raman spectroscopy unit and transmit the measurements to the FPGA.

9. The bottom hole assembly of claim 8, wherein the logging-while-drilling tool further comprises a flow meter configured to measure a flow rate of drilling slurry flowing through a central bore of the logging-while-drilling tool.

10. The bottom hole assembly of claim 8, wherein each Raman spectroscopy unit has an annular shape with a central bore to enable drilling fluid to flow through a center of the Raman spectroscopy unit.

11. The bottom hole assembly of claim 8, wherein the wireless communication unit is configured to receive data from a second wireless communication unit and forward the data to the FPGA.

12. The bottom hole assembly of claim 8, wherein the logging-while-drilling tool further comprises a light source optically coupled to each Raman spectroscopy probe.

13. The bottom hole assembly of claim 12, wherein each Raman spectroscopy probe comprises a light source outlet and a detector to capture scattered light.

14. The bottom hole assembly of claim 8, wherein the logging-while-drilling tool further comprises a power module disposed at an end of the logging-while-drilling tool, wherein the FPGA is disposed within the power module, and the power module comprises a wireless communications device communicatively coupled to the FPGA to receive the data from each wireless communication unit.

15. A method for characterizing gas in a wellbore, the method comprising:
capturing light scattered by fluid in the wellbore using two or more Raman spectroscopy probes in an underbalanced coiled tubing drilling logging-while-drilling tool;
wirelessly receiving data, from each Raman spectroscopy probe by a field programmable gated array (FPGA) disposed in the logging-while-drilling tool, the data representing the captured light; and
identifying a gas composition of the fluid in the wellbore based on Raman spectra formed using the data from each Raman spectroscopy probe.

16. The method of claim 15, further comprising, geosteering a well trajectory of the wellbore by controlling a direction of a drill bit based on the identified gas compositions.

17. The method of claim 16, wherein the direction of the drill bit is determined based on locations of the Raman spectroscopy probes on the logging-while-drilling tool from which a desired gas composition is identified.

18. The method of claim 15, further comprising transmitting data from the FPGA to a computing device located for access by an end user.

19. The method of claim 15, further comprising:
measuring a flow rate of drilling fluid flowing through the logging-while-drilling tool; and
determining an influx velocity of the drilling fluid.

20. The method of claim 15, further comprising:
receiving, by a repeater associated with a first Raman spectroscopy probe of the Raman spectroscopy probes, second data transmitted from a second Raman spectroscopy probe; and
transmitting, by the repeater, the second data to the FPGA.
